(19) United States
(12) Patent Application Publication
(10) Pub. No.: US 2026/0346594 A1
(43) Pub. Date: Nov. 5, 2026

(54) METHODS AND CARRIERS FOR MAKING COMMUNICATION DEVICES

(71) Applicant: Avery Dennison Corporation, Mentor, OH (US)

(72) Inventors: Eric L. BARTHOLOMEW, Mill Hall, PA (US); Vivek PANDEY, Willoughby, OH (US)

(21) Appl. No.: 19/663,904

(22) Filed: Apr. 30, 2026

Related U.S. Application Data
(60) Provisional application No. 63/797,208, filed on Apr. 30, 2025.

(51) Int. Cl. B32B 37/12; B32B 3/30; B32B 38/00

(52) U.S. Cl. CPC B32B 37/1292; B32B 3/30; B32B 38/0004; B32B 2457/00

(57) ABSTRACT

Methods of manufacturing constructions including communication devices, and carriers for making communication devices are disclosed herein. The carrier has at least one groove to contain an adhesive for bonding with an antenna.

### CROSS-REFERENCE TO RELATED APPLICATIONS

The present application claims priority to U.S. Provisional Application No. 63/797,208 filed Apr. 30, 2025, the entire contents and disclosures of which are hereby incorporated by reference.

### FIELD OF INVENTION

The present disclosure relates generally to methods of manufacturing constructions including communication devices, and to carriers used in the manufacture of such communication devices.

### BACKGROUND

Communication devices such as radio-frequency identification devices (RFID) have become increasingly prevalent in various industries for tracking, identifying, and managing items. RFID systems typically consist of tags or labels containing antennas and microchips, which can be attached to objects and read by RFID readers. These systems offer advantages over traditional barcode technology, including the ability to read multiple tags simultaneously and without direct line of sight.

Conventional RFID tags typically incorporate a carrier, commonly made of polyethylene terephthalate (PET), to support the antenna and microchip components. The antenna, typically constructed from conductive films such as aluminum, is deposited onto this carrier. While this structure provides stability and protection for the RFID components, it also introduces certain limitations.

The presence of a carrier in RFID tags contributes to increased production costs and results in a bulkier overall structure. This bulkiness can be particularly problematic when RFID tags are integrated into labels. The thickness of the carrier-based RFID tag may create noticeable protrusions or irregularities on the surface of the labeled item, potentially detracting from the aesthetic appeal of the label or product packaging.

Attempts have been made to address these issues by developing carrier-free RFID tags. One approach involves depositing an adhesive onto a release film carrier, such as a polyethylene terephthalate (PET) film coated with a release agent like silicone, and then constructing the antenna on this adhesive layer. However, this approach can lead to difficulties in maintaining the precise shape and dimensions of the antenna structure due to the tendency of the adhesive to spread beyond its intended boundaries.

There remains a need for improved methods of manufacturing tags including communication devices that can overcome the limitations of both carrier-based and existing carrier-free approaches. An ideal solution would minimize production costs, reduce bulk, maintain the integrity of the antenna structure, and allow for seamless integration with products such as labels without compromising aesthetics.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. The present disclosure relates to methods of manufacturing constructions including radio frequency communication devices, such as RFID devices, and to carriers used in connection with the manufacture of such communication devices.

In general, the method relates to making a construction including a communication device on a carrier having at least one groove. The construction may be assembled based on the adhesive that may be deposited in the groove. In some embodiments, the antenna or an inlay comprising an antenna and chip may be formed to correspond to the grooves. The construction once formed may be separated from the carrier.

In a first aspect, a method of making a construction including a communication device is provided. The method includes (i) forming a construction on a carrier by a method comprising depositing a first adhesive onto a first surface of the carrier, wherein the carrier comprises at least one groove protruding into the first surface of the carrier, wherein the at least one groove has a shape that is similar to or substantially similar to the at least one antenna, disposing a conductive film onto the first adhesive, cutting the conductive film to form substantially the same shape as the groove, thereby forming at least one antenna, and disposing a receiving substrate onto the first surface of the carrier, thereby sandwiching the antenna between the first adhesive and a second adhesive on a surface of the receiving substrate; and (ii) separating the carrier and the construction. In some embodiments, upon separation of the carrier and the construction the antenna may be transferred from the carrier to the receiving substrate, i.e. by separating the carrier from the construction. In some embodiments, the first adhesive or a portion thereof may be transferred to the construction during the separation step. In some embodiments, a chip may be attached or mounted to the antenna prior to being sandwiched. By removing the construction, the carrier may be reusable.

In a second aspect, a method of making a construction including a communication device is provided. The method includes (i) forming the construction on a carrier by a method comprising providing the carrier having at least one groove protruding into the first surface of the carrier, wherein the groove has a groove area in the plane of the first surface of the carrier, depositing a first adhesive into the at least one groove, disposing a conductive film onto the first surface of the carrier, cutting the conductive film to correspond to the groove area, thereby forming at least one antenna, and disposing a receiving substrate having a second adhesive on a surface of the receiving substrate that is opposite to the first surface of the carrier, thereby sandwiching the antenna between the first adhesive and the second adhesive; and (ii) separating the carrier and the construction. In some embodiments, the groove area has a shape that is similar to or substantially similar to the at least one antenna. In some embodiments, upon separation of the carrier and the construction the antenna may be transferred from the carrier to the receiving substrate, i.e. by separating the carrier from the construction. In some embodiments, the first adhesive or a portion thereof may be transferred to the construction during the separation step. The first adhesive may be deposited into the at least one groove by a method selected from the group consisting of roller printing, nozzle deposition, die coating and combinations thereof. In some embodiments, a chip may be attached or mounted to the antenna prior to being sandwiched. By removing the construction, the carrier may be reusable.

In another aspect, a carrier for making a communication device is provided. The carrier includes a first surface having at least one groove formed therein, wherein the at least one groove is configured to receive an adhesive for forming the communication device, and in particular the groove may be configured to receive an adhesive to adhere to an antenna for forming the communication device. In some embodiments, the carrier comprises a plurality of grooves, wherein the at least one groove has a shape that is similar to or substantially similar to the antenna.

The foregoing general description of the illustrative embodiments and the following detailed description thereof are merely exemplary embodiments of the teachings of this disclosure and are not restrictive.

### BRIEF DESCRIPTION OF FIGURES

Non-limiting and non-exhaustive examples are described with reference to the following figures.

FIG. 1a illustrates a side view of an embossed carrier, in accordance with aspects of the present disclosure.

FIG. 1b depicts a side view of a construction including a communication device being constructed according to aspects described herein.

FIG. 1c depicts a side view of a construction including a communication device being constructed according to aspects described herein.

FIG. 1d depicts a side view of a construction including a communication device being constructed according to aspects described herein.

FIG. 1e depicts a side view of a construction including a communication device being constructed according to aspects described herein.

FIG. 1f depicts a side view of a construction including a communication device being constructed according to aspects described herein.

FIG. 1g depicts a side view of a construction including a communication device being constructed according to aspects described herein.

FIG. 1h depicts a side view of a construction including a communication device being constructed according to aspects described herein.

FIG. 2a depicts a top view of a carrier having a circular shaped groove area on the first surface being constructed according to aspects described herein.

FIG. 2b depicts a top view of a carrier having a rounded square shaped groove area on the first surface being constructed according to aspects described herein.

FIG. 2c depicts a top view of a carrier having a polygon shaped groove area on the first surface being constructed according to aspects described herein.

FIG. 3 depicts a top view of a carrier having a groove area shaped in the form of an antenna being constructed according to aspects described herein.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following description sets forth exemplary embodiments of the present disclosure. It should be recognized, however, that such description is not intended as a limitation on the scope of the present disclosure. Rather, the description also encompasses combinations and modifications to those exemplary embodiments described herein.

The present disclosure relates to methods for making a construction that incorporate communication devices, and to carriers used in making communication devices. This method utilizes an embossed carrier during manufacture, and in particular, the embossed carrier may be as a fundamental component in the manufacturing process. By employing this novel technique, the method may result in a construction with precisely defined antenna structures, which may enhance the quality and performance of the communication device. This approach may provide new possibilities for incorporating communication capabilities into diverse products and materials.

Communication devices are understood to include devices that utilize wireless technology to communicate with another device. Examples include but are not limited to ultra-high frequency (UHF), near-field communication (NFC), bluetooth low energy (BLE), long-term evolution (LTE), and electronic article surveillance (EAS) inlays. Communication devices may include passive or active devices. Passive devices do not include an internal power source and are powered by electromagnetic energy transmitted from a reader. Different types of passive tags operate on different frequencies. Active devices, including an internal power source, continuously broadcast their own signal.

The method of making the construction may involve forming the construction including a communication device on an embossed carrier, and then separating the construction and the carrier. During execution of the method, the communication device transfers from the carrier to the construction. Accordingly, after separation, the communication device resides on the construction.

The embossed carrier comprises a film having a first surface. The embossed carrier has a surface feature that includes at least one groove protruding into the first surface of the carrier. As used herein, the terms “embossed carrier” and “carrier” may be used interchangeably. The at least one groove may have a shape that is similar to or substantially similar to the shape of an antenna. Any suitable antenna shape may be used, depending on the end-use of the antenna. In some embodiments, the carrier may include a plurality of grooves arranged in a repeating pattern across the first surface of the carrier. As described herein, a "groove" refers to a channel or depression in the surface of the carrier. In some embodiments, the at least one groove is configured to contain an adhesive. In some embodiments, the at least one groove may be configured to contain and may be configured to release an adhesive when the carrier and construction are separated. In some embodiments the first surface of the carrier is coated with a release composition, such as for example a silicone composition. In some embodiments, the at least one groove is coated with a release composition. In some embodiments, the first surface of the carrier and the at least one groove are coated with a release composition. In some embodiments, the carrier is an embossed release liner.

The carrier may be manufactured from any suitable materials. In some embodiments, the carrier may be made of a thermoplastic polymer resin such as for example, a polyethylene. In some embodiments, the carrier may be made of a polyethylene, such as for example, polyethylene terephthalate. In some embodiments, the carrier may be made of a material selected from the group consisting of a paper, silicone, polyurethane, polyethylene and polyethylene terephthalate, and combinations thereof. The carrier materials may be chosen for their durability, chemical resistance, and ability to maintain structural integrity during the embossing process. In some cases, the carrier may be made of any suitable material that allows for the formation of grooves. In some cases, the carrier may be made of any suitable material that allows for the deposition and the release of an adhesive. In some cases, the carrier may be made of any suitable material that allows for the reuse of the carrier in multiple production cycles.

The grooves serve as receptacles for adhesive, allowing for precise placement and containment of the adhesive. The grooves may have a shape that corresponds to the shape of an antenna, and in particular, the grooves may have a shape that is similar to or substantially similar to the antenna. This design enables the production of communication devices with well-defined antenna structures. The depth of each groove may be configured to contain a predetermined volume of adhesive necessary for supporting the communication device. In some embodiments, the predetermined volume of adhesive necessary for supporting the communication device may fill at least 70 % of the cross-sectional area of the groove or more, e.g., at least 75 % or more, at least 90 % or more, or at least 95 % or more. In some embodiments, the predetermined volume of adhesive necessary for supporting the communication device may completely fill the cross-sectional area of the groove. Any excess first adhesive that is deposited may be removed as necessary prior to forming the antenna.

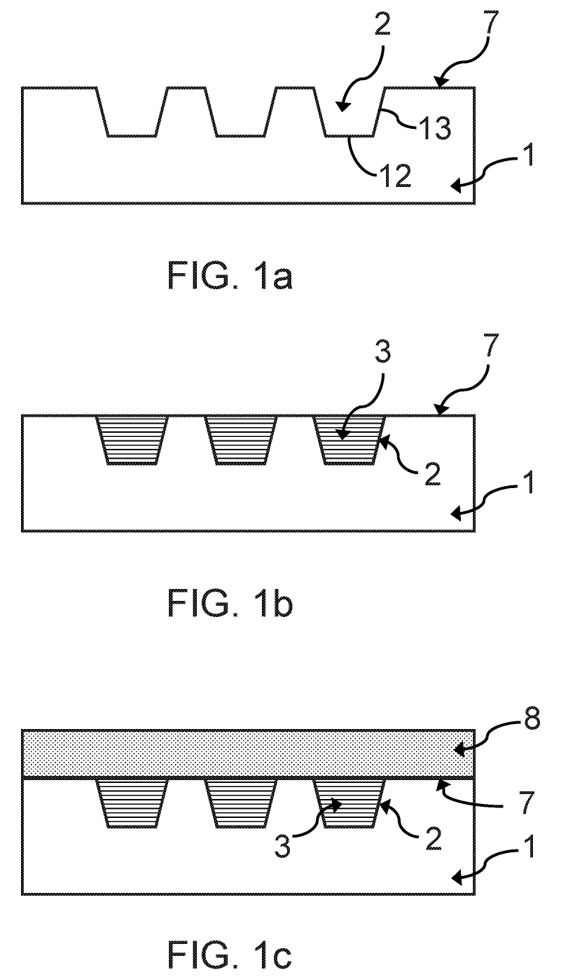

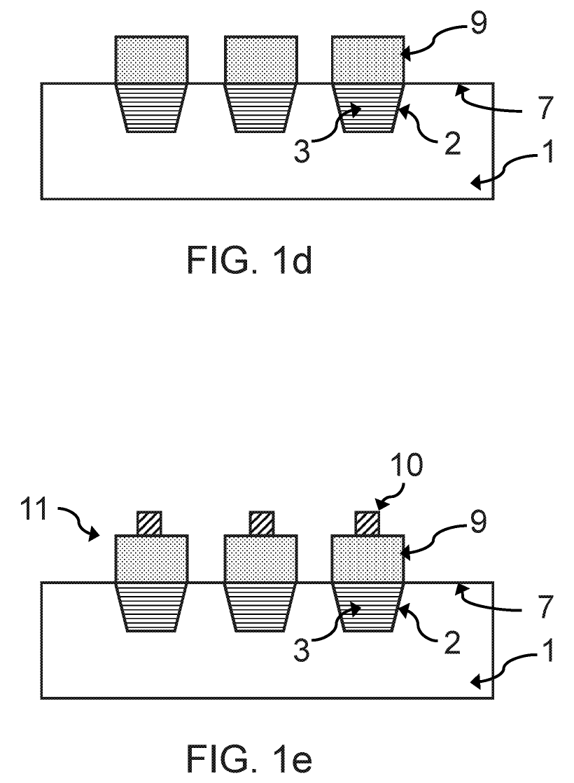

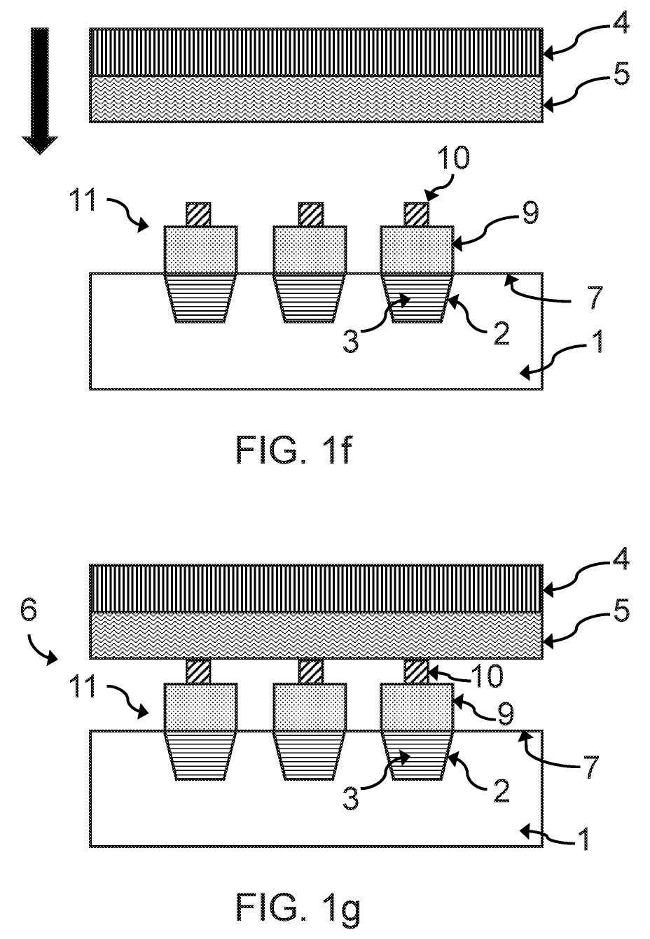

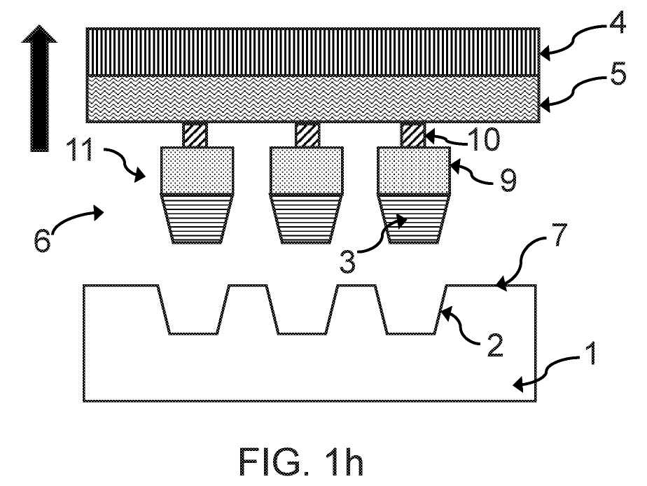

FIGS. 1a-1b illustrate a side view of an embossed carrier 1 with grooves 2 protruding into the carrier's first surface 7. The grooves 2 form the shape of an antenna 9. FIG. 1b depicts the carrier 1 with grooves 2 formed in its first surface 7 and into each grooves 2 there has been deposited a first adhesive 3. The grooves may have a shape that corresponds to the shape of an antenna 9, i.e. the shape of the groove may be similar to or substantially similar to the antenna. It should be understood the shape of the groove may be the groove area in the plane of the first surface and not the cross-sectional shape shown in FIGS. 1a-1h. In some embodiments, the first adhesive 3 may be deposited on the first surface 7 and the first adhesive 3 may fill into the grooves 2, with any excess first adhesive 3 being removed.

In some embodiments, the carrier comprises a material selected from the group consisting of a paper, silicone, polyurethane, and polyethylene, and combinations thereof. The carrier may have a thickness that is sufficient to accommodate the protruding grooves while maintaining structural integrity to allow the separation of the construction from the carrier. In some embodiments, the carrier may have a thickness from 50 microns to 5000 microns, e.g., from 100 microns to 4500 microns, from 150 microns to 3500 microns. It should be understood that thicker carriers may also be used in the embodiments disclosed herein. A carrier having sufficient thickness may be suitable for reuse in multiple manufacturing cycles.

For instance, in some embodiments, a carrier measuring 100 mm x 75 mm x 1 mm in thickness may feature grooves with a width of 500 μm and a depth of 100 μm. Depending on the antenna structure, the grooves may be arranged in a pattern. In some embodiments, one carrier may be used to manufacture multiple constructions and each of the grooves may be arranged in a repeating pattern across the first surface. In some embodiments, a carrier of similar overall dimensions might have grooves 200 μm wide and 50 μm deep, with each groove shaped to correspond to, or be substantially similar to, the antenna design selected for the communication device.

Each groove 2 may comprise a floor 12 and a wall 13. In one embodiment, the floor 12 may be flat and may be parallel to the first surface 7. In some embodiments, the floor 12 may be curved or may have folds, undulations, or an otherwise uneven surface. In some embodiments, the wall 13 may be inclined or sloped from the first surface 7 to the floor 12. Preferably the wall 13 is non-perpendicular to the first surface 7. The opening of the groove 2 on the first surface 7 defines the groove area. Preferably, the groove area may correspond to the shape of the antenna or correspond to a substantially similar shape of the antenna. In some embodiments, the opening of the groove may have a width ranging from 20 μm to 500 μm, e.g., from 25 μm to 450 μm, from 50 μm to 400 μm, from 50 μm to 350 μm, from 75 μm to 300 μm or from 100 μm to 200 μm. Depending on the shape of the antenna, the width may vary and in such embodiments, the width may be referred to as the average width. The depth of the groove may vary with the range from 5 μm to 150 μm, e.g., from 10 μm to 125 μm, from 10 μm to 100 μm, from 15 μm to 95 μm or from 20 μm to 50 μm. Preferably, the depth of the groove protruding into the first surface may be less than the width of the antenna.

The first adhesive used in the construction may be any adhesive suitable for bonding and securing the components of the communication device. In some cases, the first adhesive may be a UV-curable adhesive, which can be rapidly cured upon exposure to ultraviolet light. This type of adhesive may provide fast processing times and strong bonding properties. In some cases, the first adhesive may comprise a pressure-sensitive adhesive polymer, which can form a bond when pressure is applied to marry the adhesive with the adherend. In some embodiments, the first adhesive may be an emulsion adhesive. In some embodiments, the first adhesive may be a hot melt adhesive.

The first adhesive may be deposited onto the first surface of the carrier using various methods. In some embodiments, the first adhesive may be deposited by roller printing, which allows for precise and uniform application of the adhesive. In some embodiments, nozzle deposition may be employed, enabling controlled dispensing of the adhesive in specific patterns or quantities. In some embodiments, the first adhesive may be deposited by die coating. In some embodiments, the first adhesive may be deposited on the carrier by a method selected from the group consisting of roller printing, nozzle deposition, die coating and combinations thereof. Other suitable deposition methods may also be used, depending on the specific requirements of the manufacturing process and the properties of the adhesive. In some embodiments, the first adhesive may be selectively deposited into each of the grooves on the carrier.

The first adhesive serves to temporarily secure the antenna to the carrier, ensuring proper positioning and adherence of the antenna structure. In some embodiments, the first adhesive may be selectively deposited into each of the grooves on the carrier. Accordingly, the first adhesive may be disposed only in the grooves of the carrier. The first adhesive so-deposited precisely fills the grooves in the carrier, taking on the antenna shape of the groove area. It should be understood that the groove area, i.e., the portion of the groove in the plane of the first surface of the carrier may be referred to as the groove area. This targeted application may help to minimize adhesive usage and ensure that the adhesive is concentrated in the areas where it is most needed for antenna support. This approach may allow for accurate definition of the antenna shape and dimensions. In some embodiments, the first adhesive may be flood coated onto the carrier. The flood coated first adhesive fills the grooves and at least partially covers the surrounding surface areas of the first surface of the carrier. Flood coating the first adhesive onto the carrier may provide a more uniform first adhesive antenna-shaped layer.

Specific examples of adhesives that may be used as the first adhesive include epoxy-based adhesives, which offer strong bonding properties and resistance to environmental factors. Acrylic adhesives may also be employed, providing good adhesion to a variety of substrates and flexibility in the cured state. Additionally, polyurethane adhesives may be used, offering a combination of strength and elasticity that can be beneficial in certain applications of the communication device.

In preparation for creation of the antenna a conductive film may be disposed on the first adhesive. In those embodiments where the first adhesive may be disposed solely in the carrier grooves, the conductive film may contact the exposed surface of the adhesive, as well as the first surface of the carrier. In those embodiments where the first adhesive is flood coated on the carrier, the conductive film may contact the exposed surface of the adhesive within the grooves, as well as the surface of any adhesive on the upper surface of the carrier, and if present, any uncoated portions of the first surface of the carrier.

The conductive film may be made of any suitable material. In some cases, the conductive film may be composed of materials such as aluminum, copper, silver, or conductive polymers. The choice of material may depend on factors such as conductivity, cost, and ease of processing. For example, aluminum may be selected for its balance of conductivity and affordability. In some embodiments, the conductive sheet may be a laminate structure. For example, the conductive film may be an aluminum-PET (polyethylene terephthalate) laminate or an aluminum-BOPP (biaxially oriented polypropylene) laminate. These laminate structures may offer advantages such as improved durability, flexibility, or ease of processing compared to a single-layer conductive film. The conductive film may have a thickness ranging from 0.5 μm to 100 μm, e.g., from 1 μm to 80 μm, from 1.5 μm to 75 μm or from 2 μm to 50 μm. As used herein, the thickness refers to the average thickness of the material. Generally, the layers are uniform or substantially uniform in thickness and small variations in thickness are not detrimental to the manufacturing methods described herein. Combinations of conductive film may also be employed to achieve desired electrical and mechanical properties. Aluminum, for example, offers excellent electrical conductivity for ultra-high frequency (UHF) antenna applications.

The conductive film may have specific dimensions and properties tailored to the intended application of the communication device. In some embodiments, the conductive film may have a thickness ranging from 10 to 100 micrometers. The film dimensions may vary based on the size and shape of the desired antenna pattern. The properties of the conductive film, such as its thickness and material composition, may influence the performance characteristics of the resulting antenna. For instance, the film's conductivity may affect the antenna's efficiency in transmitting and receiving signals. The thickness of the sheet may impact factors such as the antenna's bandwidth and resonant frequency.

After the conductive film is in place, it may be cut to form at least one antenna. In some embodiments, the conductive film may be cut to form a plurality of antennas. Various cutting methods may be employed for this purpose. In some cases, die-cutting may be used to create the antenna shape. Die-cutting offers precision and repeatability, which may be beneficial for maintaining consistent antenna dimensions across multiple devices. The cutting process may be designed to closely follow the shape of the grooves in the carrier, ensuring that the resulting antenna matches the predetermined pattern. In some embodiments, the cutting may be performed to form substantially the same shape as the at least one groove, thereby forming at least one antenna. In some embodiments, the cutting may be performed such that the antenna shape is slightly larger than the groove pattern to account for potential alignment variations. Each die cut antenna may reside on an adhesive-containing antenna shaped groove.

After the conductive film has been cut into the antenna shapes, any excess conductive material may be removed. By "excess conductive film" or "excess conductive material" is meant herein as any part of the conductive film that has not been formed into at least one antenna. The removal of the excess conductive material helps to isolate the antenna structure and prevent unintended electrical connections. The removal of excess material may be accomplished through any suitable method, such as for example, peeling, vacuuming, or mechanical separation.

In some embodiments, a chip may be attached or mounted to the antenna, thereby creating a communication device including the antenna and chip. Although the chip may be attached or mounted to the conductive film prior to cutting, it is preferred to attach or mount the chip after cutting to prevent damage to the chip. The chip may be attached to the antenna by any suitable means. The chip may be directly attached to the antenna, or indirectly attached to the antenna, for example via a strap. In some embodiments, the chip is directly attached to the antenna by an adhesive.

In some embodiments, the chip may be operatively coupled to the antenna. The chip is attached on a side of the antenna opposite the first adhesive. In some embodiments, the chip is bonded directly to designated contact pads or regions on the antenna structure using conductive adhesives, solder bumps, anisotropic conductive films, or other suitable interconnect technologies. This direct-attach approach reduces component count, minimizes assembly steps, and can improve electrical performance by lowering contact resistance and parasitic inductance. Additionally, direct chip-to-antenna integration may enable a thinner, more compact construction, which is advantageous for applications requiring ultra-low-profile tags. Electrical connection between the chip and the antenna may be achieved using conductive adhesive, solder, or another suitable interconnection technique, such that the antenna and chip together form an inlay.

In some embodiments, the antenna includes one or more connection pads, terminals, or contact regions configured to electrically interface with the chip. The chip may be positioned on a surface of the antenna opposite a first adhesive in the grooves protruding into the carrier. Positioning may be performed using automated pick-and-place equipment configured to align the chip with the antenna contact regions with a predetermined positional tolerance. In some embodiments, electrical testing may be performed after chip attachment to verify antenna continuity, chip functionality, or impedance matching between the chip and the antenna.

In some embodiments, the chip may be an integrated circuit chip. The chip may comprise a logic unit that makes decisions and/or memory to store data, such as tag ID, object identifier, passwords, etc. The chip may be configured for use in an active RFID device or a passive RFID device. chips may be fabricated from semiconductor wafers, and any suitably sized chip may be used with the embodiments disclosed herein. In some embodiments, the chip may be encoded with information relating to a product with which the RFID device is to be associated. Encoding may be performed before placement of the chip on the antenna structure or after placement.

To achieve size reductions and to enable low profile antennas, the straps may be used to operatively interconnect antennas with the chip. In some embodiments, the strap includes conductive leads or contact pads that are electrically coupled to the chip’s terminals, thereby providing a reliable interface for signal transmission. These conductive pads offer a larger effective contact area compared to direct chip bonding, which reduces alignment precision requirements during assembly and improves manufacturing throughput. By minimizing the need for high-accuracy placement, strap-based interconnection supports high-speed, automated production processes while maintaining robust electrical performance. Additionally, straps can incorporate features such as pre-applied conductive adhesives or solder bumps to further streamline assembly and enhance connection reliability.

FIG. 1c illustrates the carrier 1 with grooves 2 into which a first adhesive 3 has been deposited. A conductive film 8 has been disposed onto the first adhesive 3, such that it contacts both the first adhesive 3, and the first surface 7 of the carrier 1. FIG. 1d illustrates the carrier 1 of FIG. 1c, with the conductive film 8 of FIG. 1c having been cut into the shape of a plurality of antennas 9. FIG. 1e illustrates the carrier 1 of FIG. 1d, with a chip 10 deposited on each of the plurality of antennas 9, creating a plurality of communication devices 11 on the first adhesive 3.

A receiving substrate may be provided that has a second adhesive on a surface of the substrate. In some embodiments, the receiving substrate may be disposed on or deposited onto the first surface of the carrier, with the second adhesive directed toward the first surface of the carrier, thereby forming the construction on the carrier. In some embodiments, the antenna may be sandwiched between the first adhesive and the second adhesive on the surface of the receiving substrate. In some embodiments, the antenna and the chip of the communication device may be sandwiched between the first adhesive and the second adhesive on the surface of the receiving substrate. In some embodiments, the communication device may be sandwiched between the first adhesive and the second adhesive on the surface of the receiving substrate. The second adhesive is a pressure sensitive adhesive that is configured to bond the construction to an article. Any suitable adhesive may be used, such as for example acrylic-based adhesives, silicone adhesives, or rubber-based adhesives. The second adhesive may be applied by printing, coating, or spraying, either across the entire surface of the receiving substrate or selectively applied in a pattern on the surface of the receiving substrate.

In some embodiments, the receiving substrate may be a flexible material that serves as the base layer for the construction. The receiving substrate may provide structural support for the construction. The receiving substrate may be made of any suitable material, such as for example paper, flexible fabric material, PET, or BOPP. The receiving substrate may be a monolayer or multilayer. The thickness of the receiving substrate may vary, and in some embodiments, the receiving substrate may have a thickness from 0.5 mm to 10 mm, e.g., from 0.7 mm to 5 mm, or more preferably from 1 mm to 4.5 mm.

In some embodiments, the receiving substrate includes a printable surface opposite to the second adhesive. The receiving substrate may also include a printable surface for displaying information associated with the RFID label or tag, such as product identification, branding, or tracking data. In some embodiments, the antenna and chip are not visible through the printable surface. This is advantageous, as the construction including the communication device can be attached to an article without detracting from the aesthetics of the construction. This is particularly desirable when the construction is a label.

As shown in FIGS. 1f and 1g, the receiving substrate 4 may be disposed onto the first surface of the carrier 1, sandwiching the antenna 9 and chip 10 of the communication device 11 between the first adhesive 3 and the second adhesive 5 on the receiving substrate 4, thereby forming the construction 6 on the carrier 1. Taken together the antenna 9 and chip 10 may be collectively referred to as an inlay.

During the assembly of the construction on the carrier, in some embodiments, the communication device transfers from the carrier to the construction. In some embodiments, the communication device transfers from the carrier to the receiving substrate of the construction. The construction may be removed from the carrier, for future use of the construction. In some embodiments, a liner is disposed on the construction to protect the first and second adhesives until use of the construction. The construction may be separated from the carrier by any suitable means. In some embodiments, the carrier and construction are separated by peeling or mechanical means.

As shown in FIG. 1h, the construction 6 of FIG. 1g and the carrier 1 may be separated, enabling the carrier 1 to be reused for additional manufacturing methods to form construction devices including communication devices. In some embodiments, the method may involve separating the carrier 1 from the construction 6 or the construction 6 from the carrier 1. As shown the antenna 9 may be transferred from the carrier 1 to the receiving substrate 4 when the carrier 1 and the construction 6 are separated. In addition, it is preferred that the first adhesive 3 or a substantial portion of the first adhesive 3 may be transferred from the carrier 1 to the receiving substrate 4. By removing the first adhesive 3 or a substantial portion of the first adhesive 3 the carrier may be reused without having to remove debris or residue in the protruding grooves.

In some embodiments there is provided a method of making a construction including a communication device of depositing a first adhesive onto a first surface of the carrier, wherein the carrier comprises at least one groove protruding into the first surface of the carrier in a shape of an antenna, forming an inlay comprising an antenna and chip on the deposited first adhesive, disposing a receiving substrate to sandwich the inlay between the first adhesive and a second adhesive on a surface of the receiving substrate, removing the carrier to form the construction.

In some embodiments there is provided a method of making a construction including a communication device of depositing a first adhesive into at least one groove on the carrier, wherein the groove has a groove area in the plane of the first surface of the carrier, forming an inlay on the first adhesive comprising an antenna and chip, disposing a receiving substrate having a second adhesive that is opposite to the first surface of the carrier, thereby sandwiching the antenna between the first adhesive and the second adhesive, and removing the carrier to form the construction.

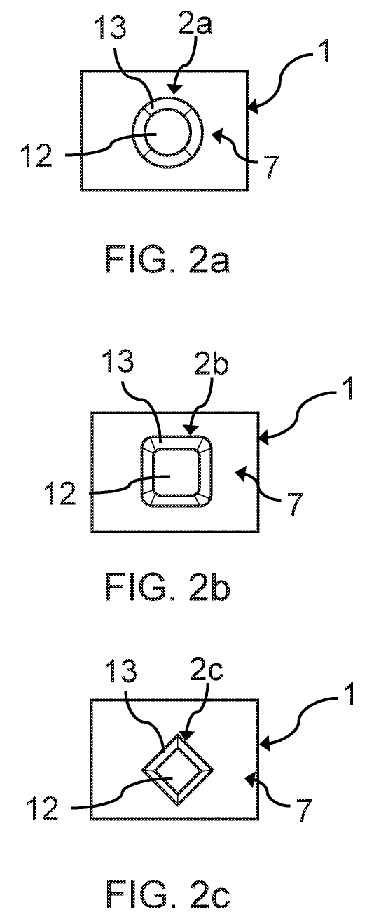

FIGS. 2a–2c illustrate example groove areas for defining antenna shapes. FIGS. 2a–2c are top views of the first surface 7 of the carrier 1 and illustrate groove areas formed in the plane of the first surface 7. In FIG. 2a, the groove area 2a is in the shape of a circle for use with an antenna having a circular shape. In FIG. 2b, the groove area 2b is in the shape of a rounded square. In FIG. 2c, the groove area 2c is in the shape of a polygon, such as a diamond or a square. Other polygonal groove areas may be used depending on the antenna configuration. Each of the groove areas shown in FIGS. 2a–2c lies in the plane of the first surface 7 of the carrier 1 and has a shape that corresponds to, or is similar to or substantially similar to, the shape of the antenna. Walls 13 of the grooves may slope toward a floor 12 of the grooves, and the floor 12 may have the same or a substantially similar shape as the groove area. In some embodiments, the walls 13 are curved or otherwise sloped. The illustrated groove areas are exemplary, and it should be understood that the groove area may have any suitable shape corresponding to the antenna.

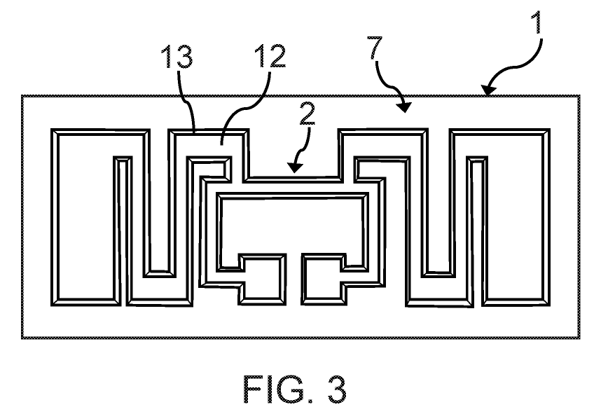

FIG. 3 is an exemplary embodiment of a groove 2 corresponding to the shape of an antenna. The antenna may be shaped as a single dipole, dual dipoles, a folded dipole, slot, or spiral coil or other suitable antennas used for communication devices. FIG. 3 is a top view of the first surface 7 of the carrier 1 and illustrates the groove 2 as a groove area corresponding to the antenna shape. It should be understood that the antenna illustrated in FIG. 3 is exemplary, and that other antenna shapes are contemplated by the embodiments disclosed herein. The groove area shown in FIG. 3 lies in the plane of the first surface 7 of the carrier 1. As illustrated, walls 13 of the groove may slope toward a floor 12 of the groove, which may have the same or a substantially similar shape as the groove area. The width of the groove area may vary along the antenna shape depending on antenna design requirements, such that certain portions of the groove area are wider than others.

The present disclosure also relates to a carrier for making a communication device. The carrier may include a first surface having at least one groove formed therein, wherein the at least one groove is in the shape of an antenna or substantially similar to the shape of an antenna and may be configured to receive an adhesive for forming the communication device. In some embodiments, the at least one groove comprises a plurality of grooves, each groove having a shape corresponding to the antenna. Each groove in the plurality of grooves may have a similar shape to correspond to the shape of the antenna. In some embodiments, the plurality of grooves are arranged in a repeating pattern across the first surface of the carrier. In some embodiments the first surface of the carrier is coated with a release composition, such as for example a silicone composition. In some embodiments, the at least one groove is coated with a release composition. The release composition may coat the walls and/or floor of each of the grooves. In some embodiments the first surface of the carrier and the at least one groove are coated with a release composition. In some embodiments, the carrier is an embossed release liner. In some embodiments, the carrier may be reusable for multiple cycles of communication device production. In some embodiments, the at least one groove has a depth configured to contain a predetermined volume of adhesive for supporting the communication device.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. References to the singular are also intended to include the plural, unless the context clearly indicates otherwise.

A number of implementations have been described. Nevertheless, it will be understood that various modifications may be made without departing from the spirit and scope of the disclosure. Accordingly, other implementations are within the scope of the following claims.

What is claimed is:

1. A method of making a construction including a communication device, comprising:
(i) forming a construction on a carrier by a method comprising:
depositing a first adhesive onto a first surface of the carrier, wherein the carrier comprises at least one groove protruding into the first surface of the carrier,
disposing a conductive film onto the first adhesive,
cutting the conductive film to form substantially the same shape as the groove, thereby forming at least one antenna, and
disposing a receiving substrate onto the first surface of the carrier, thereby sandwiching the antenna between the first adhesive and a second adhesive on a surface of the receiving substrate; and
(ii) separating the carrier and the construction.

2. The method of claim 1, wherein the antenna is transferred upon separation of the carrier and the construction.

3. The method of claim 1, wherein the at least one groove has a shape that is similar to or substantially similar to the at least one antenna.

4. The method of claim 1, wherein the first adhesive is deposited on the carrier by a method selected from the group consisting of roller printing, nozzle deposition, die coating and combinations thereof.

5. The method of claim 1, wherein the first adhesive is deposited in the at least one groove on the carrier.

6. The method of claim 1, wherein the first adhesive is flood coated onto the first surface of the carrier.

7. The method of claim 1, further comprising attaching a chip to the antenna.

8. The method of claim 1, wherein the receiving substrate comprises a printable surface opposite to the second adhesive, and wherein the antenna and chip are not visible through the printable surface.

9. A method of making a construction including a communication device, comprising:
(i) forming the construction on a carrier by a method comprising:
providing the carrier having at least one groove protruding into the first surface of the carrier, wherein the groove has a groove area in the plane of the first surface of the carrier,
depositing a first adhesive into the at least one groove,
disposing a conductive film onto the first surface of the carrier,
cutting the conductive film to correspond to the groove area, thereby forming at least one antenna, and
disposing a receiving substrate having a second adhesive on a surface of the receiving substrate that is opposite to the first surface of the carrier, thereby sandwiching the antenna between the first adhesive and the second adhesive; and
(ii) separating the carrier and the construction.

10. The method of claim 9, wherein the antenna is transferred upon separation of the carrier and the construction.

11. The method of claim 9, wherein the first adhesive is deposited into the at least one groove by a method selected from the group consisting of roller printing, nozzle deposition, die coating and combinations thereof.

12. The method of claim 9, wherein the conductive film comprises aluminum, copper, silver, or conductive polymers.

13. The method of claim 9, wherein the first adhesive is flood coated onto the first surface of the carrier.

14. The method of claim 9, wherein the receiving substrate comprises a printable surface opposite to the second adhesive, and wherein the antenna and chip are not visible through the printable surface.

15. A carrier for making a communication device, comprising:
a first surface having at least one groove formed therein, wherein the at least one groove is configured to receive an adhesive to adhere to an antenna for forming the communication device, wherein the at least one groove has a shape that is similar to or substantially similar to the antenna.

16. The carrier of claim 15, wherein the at least one groove comprises a plurality of grooves.

17. The carrier of claim 16, wherein the plurality of grooves are arranged in a repeating pattern across the first surface of the carrier.

18. The carrier of claim 15, wherein the carrier is reusable for multiple cycles of communication device production.

19. The carrier of claim 15, wherein the carrier comprises a material selected from the group consisting of paper, silicone, polyurethane, and polyethylene, and combinations thereof.

20. The carrier of claim 15, wherein the at least one groove has a depth configured to contain a predetermined volume of adhesive for supporting the communication device.
